(19) United States
(12) Patent Application Publication
(10) Pub. No.: US 2014/0085373 A1
(43) Pub. Date: Mar. 27, 2014

(54) ACCESSORY TO BE APPLIED TO ANY PRINTING-LINE FOR PROVIDING AN UNIVOCAL PATTERN BY MEANS OF SPRINKLING MARKING PARTICLES OF GLITTER, MICRODROPLETS OR OF OTHER MATERIALS HAVING DIFFERENT COLORS AND SIZES, AND METHOD THEREOF

(71) Applicant: Claudio Selva, Biella Pavignano (IT)

(72) Inventor: Claudio Selva, Biella Pavignano (IT)

(21) Appl. No.: 14/114,696

(22) PCT Filed: Apr. 24, 2012
(86) PCT No.: PCT/IT2012/000119

§ 371 Date: Oct. 29, 2013

(30) Foreign Application Priority Data
May 13, 2011 (IT) BI2011A000003
Jun. 13, 2011 (IT) BI2011A000004

(51) Int. Cl. B42D 15/10

(52) U.S. Cl. CPC B42D 15/10
USPC 347/20

(57) ABSTRACT

An accessory for a printing line provided with a surface (31) for feeding a paper web (32) for producing a unique pattern on said paper web by sprinkling marking particles, comprising adjustable means for sprinkling a desired amount of particles on an adhesive portion (4) of the paper web, means for stabilizing (11, 24) said marking particles sprinkled on said adhesive portion (4), and corresponding method comprising the steps of sprinkling on said adhesive portion an amount of marking particles, sucking in from said paper web a residual amount of particles not withheld by the adhesive portion, and stabilizing the marking particles with held by the adhesive portion.

### TECHNICAL SECTOR

In an increasingly global world, in the production, marketing, and circulation of consumer goods of every type of marketable product, there is increasingly felt the need to defend the product or the trademark from colourable imitations, counterfeiting, and extraterritorial triangulations.

From here there arises the need for product defence, by marking each individual product with a non-reproducible and easily identifiable “fingerprint” that will enable the end customer or entrusted bodies to verify, with absolute certainty, the originality of each individual product.

### STATE OF THE ART

Known from WO2010001203, filed in the name of the present applicant, is a unique label for counterfeiting use that can be obtained with a random distribution of particles on a substrate, for subsequent telematic reading, filing, and comparison.

This known solution leaves, however, open some requirements for greater flexibility of the process of distribution of the particles on a printing line, and for optimization of the entire cycle in order not to disperse the particles used.

### PURPOSE OF THE INVENTION

A first purpose of the invention is to propose an accessory than can be applied to any printing line and is able to satisfy the requirement of a marking system for defence of products or trademarks from imitation and/or counterfeiting.

A second purpose is to propose an accessory for printing lines that is flexible in use and suitable for automatic operation on printing lines of various types that function at rates of feed that may even vary.

A third purpose is to propose a method to be implemented by means of any printing line for producing on a sheet a unique drawing by sprinkling particles with anti-counterfeiting marking function.

### SUMMARY OF THE INVENTION

The purposes of the invention are achieved with an accessory and a method according to at least one of the annexed claims.

A first advantage lies in that with the accessory and method according to the invention there is obtained a marking of any individual product with a “fingerprint”, i.e., a non-reproducible and easily identifiable mark, which enables the end customer or entrusted bodies to verify, with absolute certainty, the originality of each individual product.

### LIST OF THE DRAWINGS

FIG. 1 shows a first embodiment of the accessory of the invention applied to a generic printing line;

FIG. 2 shows the accessory of FIG. 1 with a detail of the pneumatic circuit;

FIG. 3 shows a cylinder for storage and delivery of the microdrops in the embodiment of the accessory of FIG. 1;

FIG. 4 shows a detail of the cylinder of FIG. 1 and of a pyramidal chute for directing the microdrops;

FIG. 5 is a schematic illustration of a succession of processing steps during operation of the accessory;

FIG. 6 shows a second embodiment of the accessory; and

FIGS. 7 and 8 are schematic illustrations of the steps of a method according to the invention.

### DETAILED DESCRIPTION

With reference to the attached drawings, which are provided by way of non-limiting example of embodiment of the invention, an accessory is described, which can applied on all reel-fed printing machines and has the purpose of providing a unique and personalized drawing continuously directly on the package, on the label, or any other printed material.

There now follows a detailed description of the individual parts of the invention and of their functions to provide a non-binding example in order to illustrate the invention, the process, and the various passes of the accessory, for creating a unique mark obtained with marking particles, for example micro-drops of colour, directly on the printing line and on the reel being processed of a flexographic machine.

With reference in particular to FIGS. 1-5, the accessory is made up of a bottom base 1 joined with hinges to a top part 2.

After it has been opened in book fashion, it is positioned an the tensioned paper of the reel 3 being processed, and has the purpose of providing a series of squares 4 preferably with a side of a few centimetres, each with a unique drawing.

These different drawings are obtained by dispersion, suction, and squeezing of encapsulated microdrops, preferably microdrops of various colours.

In the embodiment described, the invention comprises a central cylinder 19 for storing microdrops of various colours.

The cylinder can have a variable diameter according to the need of storage of the product and to the duration of continuous feed for printing. The length of the cylinder is proportional to the width of the paper on the printing line. The cylinder is closed on one side, whereas on the other a closing plug enables initial supply thereof, by pouring therein the microdrops of various colours to be spread over a square 4 previously printed with a transparent paint having a high degree of adhesiveness.

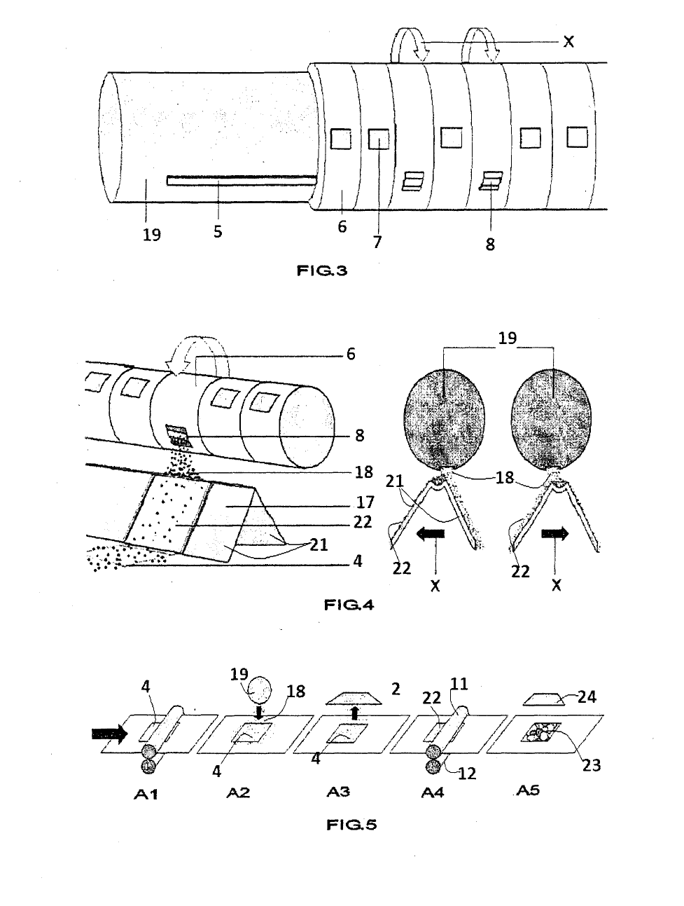

On the bottom of the central cylinder, running throughout the length, is a slot 5 of a few millimetres for outlet of the product stored therein. The slot, throughout its length, is enveloped by a series of rings of variable width 6 each of which having a slit 7 of a few centimetres, which has the purpose of adjusting the outlet and directing the microdrops of various colours in such a way that they drop directly on the underlying pyramid such as a dihedral deviator with central overflow groove and consequently, via the chute, onto the square printed with adhesive transparent paint. By rotating the rings 7 in a clockwise direction X (FIG. 3) and positioning the slits on the outlet slot 8 of the central containing cylinder the outlet flow and width of the microdrops of colour are regulated and dosed, according to the position of the underlying square with adhesive paint and the rate of feed of the paper on the printing line.

The microdrops are sprinkled over the adhesive paint of the square 4 and outside said square, and then, as they advance, pass underneath a plate 2, which removes by suction the excess microdrops that have spread outside the square, whereas those that have dropped within the square remain anchored as a result of the adhesive paint. The microdrops sucked in, via a manifold 9, 10, are conveyed directly to the central sprinkling cylinder.

A vertical air barrier closes the suction plate as a guarantee that no microdrop will remain spread outside the square with adhesive paint.

As the paper advances, the square with the microdrops on top, which have adhered to the adhesive paint, passes through a roll, for example a roll coated with Rilsan 11, which via a counter-roll 12 squeezes the microdrops causing the various colours to come out thus creating a unique multicolour drawing.

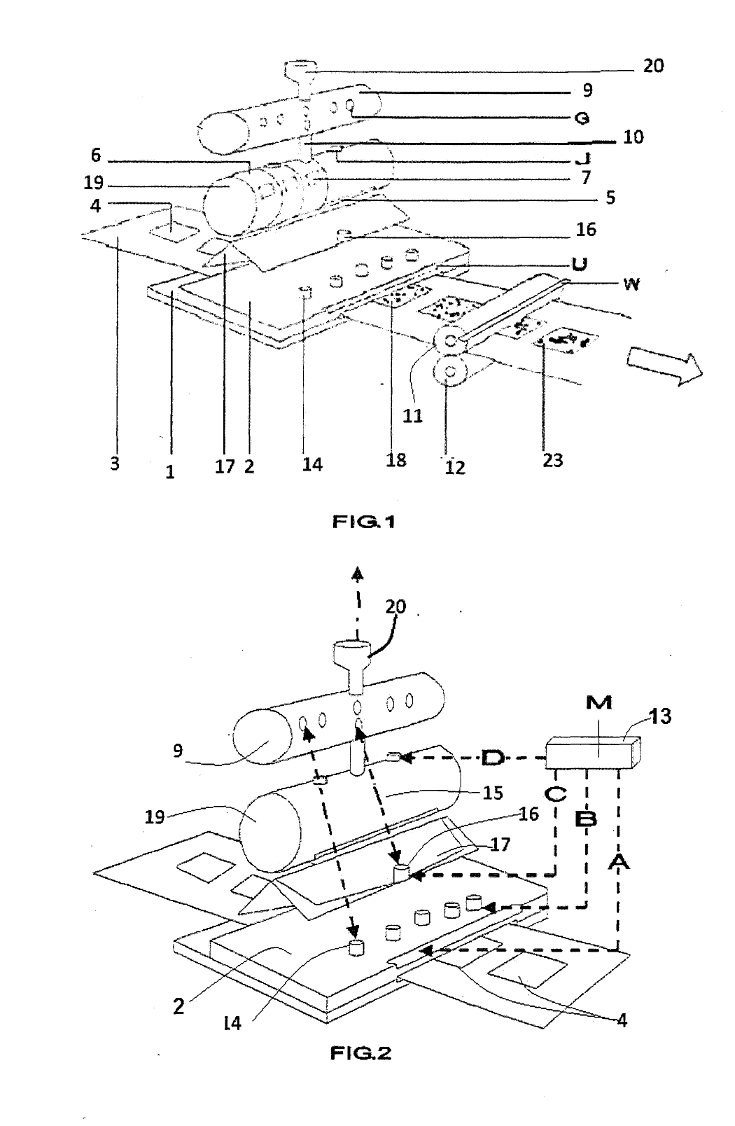

The accessory is fed and functions by mere entry of compressed air illustrated in detail in FIG. 2.

From a control unit there depart three sections of compressed air:

the first section A supplies the vertical air barrier of the suction plate 2;

the second section B is connected via pipes to five mouths 14 of the suction plate, which, after sucking in the excess microdrops of colour that have dropped outside the square 4 with adhesive paint, conveys them to the central cylinder via the manifold 9;

in the third section C there departs a pipe 15 connected to the suction mouth 16 of the pyramid 17, positioned on the side facing the direction of feed of the paper.

The mouth 16 sucks in the microdrops of colour that have spread outside the square 18 and conveys them into the central cylinder via the manifold 9 and the pipe 15.

Finally, from the third section D there departs a pipe that supplies a hammer set on the central cylinder, which has the function of levelling by shaking them the microdrops of colour stored inside.

A cyclone pre-filter 20 for outlet of the suction air completes the compressed-air cycle.

In the graphic printing, at start-up of the machine, the paper starts at a minimum rate of feed and then reaches a standard rate that is around 60-80 m per minute. It is thus important to regulate the dosage, amount, and distribution of the microdrops of colour as a function of the rate of feed of the paper. In FIG. 4, the pyramid 17 with central overflow groove is positioned underneath the central cylinder, and the microdrops 18 of colour at outlet drop on both of the side chutes 21 of the pyramid 17. By shifting (FIG. 4, arrow X) the side chutes 21 to the right or to the left the dosage and the amount 22 of microdrops of colour to be spread is adjusted according to the rate of feed of the paper.

This adjustment enables always a constant number of microdrops of colour to be obtained within the squares 4 with adhesive paint.

FIG. 5 summarizes, schematically and in a straightforward way, the various steps of the process for creating a unique drawing with the accessory described above. A square 4, for example of 2 cm×2 cm (FIG. 5, step A1), is printed with a transparent paint. The square then advances and passes under the central sprinkling cylinder, which coats it with microdrops of colour, which adhere to the adhesive paint of the square 4 (FIG. 5, step A2). Then, advancing further, it passes under a suction plate 2 that sucks in the excess microdrops of colour located outside the square 4 with adhesive paint (FIG. 5, step A3).

As it advances further, the square with the microdrops 22 passes through a series of rolls 11, 12, which squeeze the microdrops of colour creating an original and non-reproducible unique drawing 23 (FIG. 5, step A4). Finally, the unique pattern 23 passes underneath a UV lamp 24 for drying thereof (FIG. 5, step A5).

In summary, the accessory illustrated in FIGS. 1-5 is an accessory for creating continuously on the printing line and directly on the print unique or identifying patterns, said accessory being constituted by a central cylinder, which serves as reservoir for containment of the product to be spread.

This cylinder is enveloped by a series of perforated outer rings that regulate the flow and dispersion of the material. An intermittently operated hammer levels the product within the reservoir. Positioned underneath the cylinder is a pyramid (e.g. a dihedral deviator) with a central groove, which, by being displaced, has the purpose of conveying, dosing and directing, via the chutes, the material to be spread on the square. Next, a suction plate complete with an air barrier is placed for removing the excess product spread outside the square. The plate is connected via pipes to a manifold with an air-outlet mouth, which recovers the material sucked in and deposits it in the central cylinder. The accessory is completed by a series of rolls with collecting doctor's blade for squeezing the microdrops.

The accessory described above, owing to its simplicity and possibility of industrial application, constitutes an innovative and complementary element in the sector of graphic printing, adding further value and meeting anticounterfeiting or marketing requirements on each individual print or packaging. In practice, some details of the invention and of the method described may vary according to the need of application and of overall dimensions of each individual printing machine and their operativeness, without departing from the sphere of protection and hence from the scope of the invention.

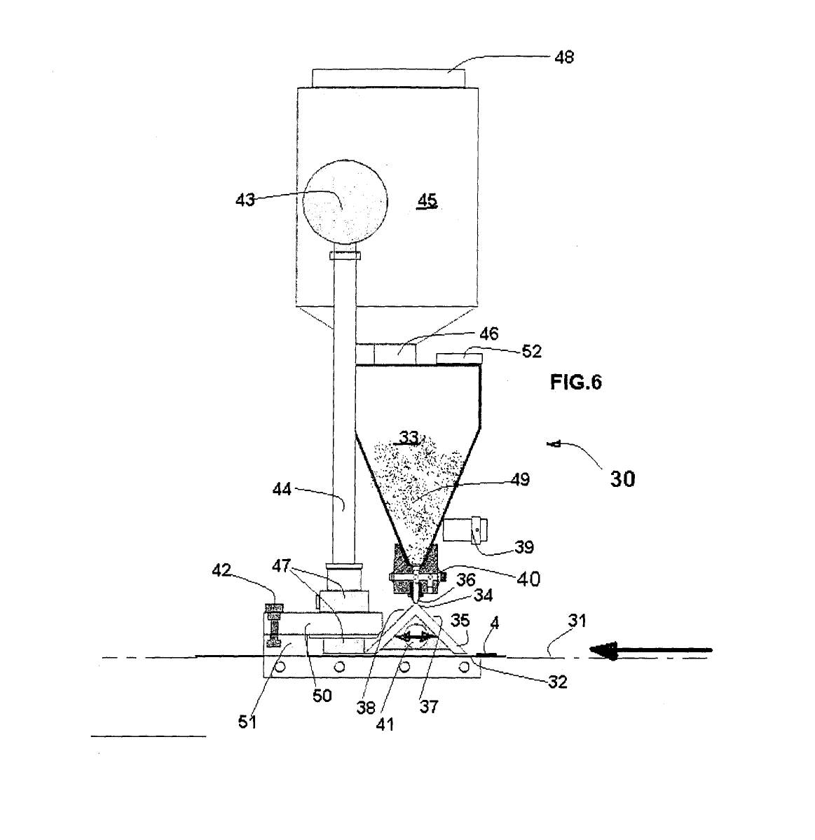

With reference to FIG. 6, a preferred embodiment of an accessory according to the invention is described, designated as a whole by 30, which can be applied to a generic printing line provided with a surface 31 for feeding a sheet of paper 32.

In the embodiment described the accessory comprises means for sprinkling on an adhesive portion 4 of the sheet of paper an adjustable amount of particles 49 designed to define a unique pattern identifying the portion 4 and any object to which it is applied.

Preferably, the particles 49 are constituted by microdrops of colour encapsulated in a brittle protective shell.

Still more preferably, the adhesive portion 4 is obtained by means of a layer of water paint or the like, and the encapsulated microdrops constitute water-soluble microgranules designed to dissolve, i.e., release the colour contained therein, once in contact with the water-based paint.

In the preferred embodiment described, delivery of the particles occurs by means of a reservoir 33, which is set above the sheet 32, with a top lid 52 and terminates at the bottom with one or more nozzles 36 for sprinkling the particles on the vertex 34 of a deviator 35.

Advantageously, the nozzles 36 are distributed in width (i.e., in the direction coming out of the plane of the drawing) according to the size of the sheet 32 and the position of the portions 4 and are controlled by a regulating system 40 for varying the outlet port for outlet of the particles 49.

Preferably, the reservoir 33 is provided with a hammer 39 that is able to strike the reservoir and prevent lumping of the particles contained therein.

According to the invention, the deviator 35 is shaped like an elongated pyramid, extending for at least part of the width of the sheet 32 and consequently has a double chute, a first chute 37 facing upstream and a second chute 38 facing downstream with respect to the direction of feed of the sheet 32.

Advantageously, the deviator 35 can be positioned in an adjustable way with respect to the nozzle 36 in order to be able to regulate the amount of particles delivered from the reservoir, which are to be deviated on the first chute 37 or on the second chute 38, respectively.

With this solution it is possible to adjust or synchronize the amount of particles that are to slide down the first chute 37 and drop on the portion 4, according to the rate of feed of the sheet 32.

For example, the accessory can envisage one or more nozzles 36 provided with an adjustment screw 40 for opening/closing the passage of the particles and can moreover comprise a mechanism 41 for millimetric shifting of the pyramid 36 for adjustment of the position of said deviator.

In a preferred embodiment, there may moreover be provided automatic means for adjusting the position of the deviator 36 according to the rate of feed of the sheet 32 and the amount of particles 49 that are to drop on the adhesive portion 4.

Moreover, provided downstream of the delivery of the microdrops 49 are means for intake of the excess particles that have spread outside said portion 4 and the particles deviated on the second chute 38.

Preferably, the suction and recirculation means comprise a suction device 47 set downstream of the second chute 38 of the deviator 36 with respect to the direction of feed of the sheet of paper and provided with means 42 for adjustment in height, constituted, for example, by screw elements 42 capable of raising or lowering, with respect to a fixed base 51, a plate 50 fixed with respect to the suction device 47.

It is understood that the term “suction device” is meant to indicate one or more suction mouths distributed above the sheet 32 for collecting the particles deposited thereon.

The suction and recirculation means further comprise an assembly 45 provided with an air-outlet filter 48 and designed to collect the residual particles sucked in by the suction device 47 and conveyed into the assembly 45 through a manifold 43, which is in turn connected via pipes 44 to the suction device 47 and is connected, at outlet, to the reservoir 33 via a pipe 46 for reintegration therein of the recovered particles.

Finally, provided downstream of the suction device 47 are means for stabilizing the particles sprinkled on the adhesive portion 4.

The solutions that can be adopted for stabilizing the particles are, for example, of the type already described previously, and in particular can comprise rolls functionally similar to the rolls 11, 12 suitable for squeezing the encapsulated microdrops, and drying lamps for drying the liquid component of the drops.

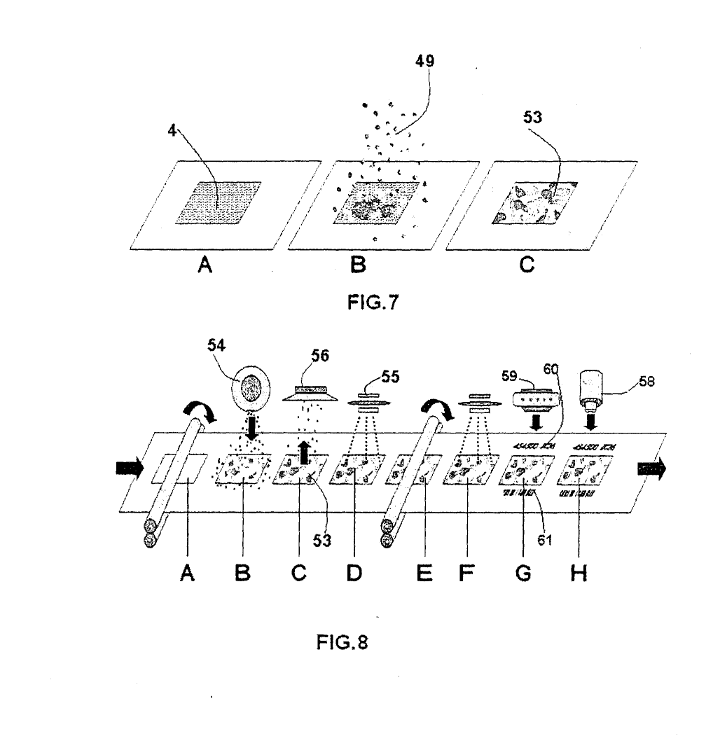

With reference to FIGS. 7 and 8, a method according to the invention is described for creating a uniquely differentiated pattern via graphic printing, with transparent paint and microdrops or microgranules of water-soluble pigments of different colours.

The printing method described can in part meet two requirements that are markedly felt and of current importance in the sector of counterfeiting and marketing. The first and most important is to provide a unique and non-reproducible mark on each individual product as a guarantee of originality, and for countering colourable imitation. The other is the need for graphic novelty for marketing purposes in order to meet the requirements for new printing solutions for packaging so as to provide a distinctive presentation with respect to competitors in exhibiting products and at the same time provide a marked visual appeal. The method amply meets the aforesaid two requirements, enabling creation, during graphic printing, of a coloured pattern obtained with a very simple technique of application.

For example, in the case of a unique recognition pattern, a square 4 is printed with water-based transparent paint (FIG. 7, step A).

Microgranules 49 of pigment of various water-soluble colours are sprinkled over the square (FIG. 7, step B) to obtain a pattern 53 (FIG. 7, step C).

Advantageously, each pattern is unique and non-repeatable since it is created by the randomness of sprinkling of the microgranules of coloured pigments on the paint.

There now follows a detailed presentation of the various steps of the method. These steps are implemented progressively during feeding of the paper and directly on the standard printing line of the graphic printing machine. Described hereinafter by way of example that in no way limits the effects of the invention is the creation of a unique coloured pattern with a side of a few centimetres on self-adhesive paper, which can then be applied on any product and serves as “fingerprint” to defend originality and for a future anti-counterfeiting check. First a square with a side of 2 cm is printed with a transparent water-based paint having a specific formulation, which undergoes a fast drying under standard heat lamps installed on the printing machine (FIG. 8, step A).

As the paper is fed, the square with the paint passes underneath a sprinkling cylinder 54, which sprinkles the microgranules of water-soluble pigment of various colours, which are distributed inside the square itself and around it (FIG. 8, step B). The microgranules of coloured pigments that drop within the square, given that they are water-soluble, in contact with the water-based transparent paint, are dissolved and expand overlapping one another and forming a unique and non-repeatable pattern 53, whereas the microgranules of pigments that have dropped outside the square not in contact with the water-based paint remain intact and are sucked back in via a suction plate 56 (FIG. 8, step C).

The square with the corresponding coloured pattern then passes underneath a heat lamp 55, which fixes and dries it (FIG. 8, step D). In the next step, as the paper advances further along the printing line, the square and corresponding pattern are protected by printing thereon a transparent UV paint, to prevent wear and for stabilization of the colours (FIG. 8, step E). Finally, as the paper advances further, the pattern passes under a second UV lamp 55, which dries the transparent paint (FIG. 8, step F) and stabilizes the pattern obtained.

FIG. 8 is moreover a schematic representation of a step G of optical reading of the pattern.

In summary, the method illustrated in FIGS. 7-8 envisages printing a circumscribed primer layer with a water-based transparent paint. Sprinkled on the circumscribed paint are the microgranules of water-soluble pigments of various colours. The coloured microgranules that drop on the water-based paint dissolve, mix, and overlap creating a unique multicolour mark.

The method described represents an absolute novelty in the field of graphic printing since it affords the possibility of departing from production in series and of personalizing each individual print. The simplicity of application, directly on a standard printing line, renders the method highly advantageous from the economic standpoint and adaptable at an industrial level to the various printing machines of both the flexographic and the roto-offset sectors.

To complete and enhance the unique pattern described, there now follows, merely by way of information that in no way limits the method itself, a summary of possible steps for personalizing the unique pattern that meets requirements of protection against counterfeiting and enables check of originality of the product. After painting, using a laser printer an encrypted algorithmic alphanumeric number 60 and a two-/three-dimensional code 61 are combined with the unique pattern for identification and filing thereof in a central storage system (FIG. 8, step G). Finally, the pattern with corresponding codes is photographed with a high-definition digital camera 59 and the signal is sent to a central storage system 58 for filing (FIG. 8, step H).

When the unique pattern is applied to the product, it constitutes a “fingerprint” proper thereof, guaranteeing originality and with the possibility for the consumer or an inspector, with an ordinary mobile-phone apparatus, to send the alphanumeric code or the photograph of the unique pattern to the central filing system, which, in real time, compares it with the data previously filed and sends the result of the comparison. The novelty of this unique print is the absolute certainty of recognizing the original print from a copy. The unique pattern is generated by mixing pure pigments, which overlapping create nuances of colour with various hues that are impossible to replicate, while in the reproduction of graphic or digital prints the hues are generated with the four base colours by dithering or by the pixels. Thus, the original pattern can be readily distinguished from the counterfeited one by the presence of the dithering or the pixels.

In practice, some details of the invention and of the method described herein may vary according to the requirements of size and visibility of each unique pattern, without thereby departing from the sphere of protection and hence the scope of the invention.

1) An accessory for a printing line provided with a surface (31) for feeding a sheet of paper (32) for producing a unique pattern on said sheet by sprinkling marking particles, characterized in that it comprises:
adjustable means for sprinkling a desired amount of particles on an adhesive portion (4) of the sheet of paper; and
means for stabilizing said marking particles sprinkled on said adhesive portion (4).

2) The accessory according to claim 1, further comprising suction and recirculation suction means for re-introducing into circulation excess particles that have spread outside said portion (4).

3) The accessory according to claim 1 or claim 2, wherein said adjustable means for distribution of particles comprise a reservoir (33) with a nozzle (36) for sprinkling particles on the vertex (34) of an underlying double-chute deviator (35), which can be positioned in an adjustable way with respect to said nozzle in order to regulate the amount of particles supplied by the reservoir that are to be deviated on a first chute (37) of the deviator (35) or on a second chute (38) of the deviator.

4) The accessory according to any one of the preceding claims, comprising a hammer (39) that acts on the reservoir (33), which can be operated to maintain flowability of the particles.

5) The accessory according to any one of the preceding claims, wherein said nozzle (36) is provided with an adjustment screw (40) for adjusting opening/closing of the passage for the particles.

6) The accessory according to any one of the preceding claims, comprising a millimetric shifting mechanism (41) for regulating the position of said deviator (35).

7) The accessory according to any one of the preceding claims, wherein said suction means comprise a suction device (47) set downstream of the sprinkling means with respect to the direction of feed of the sheet of paper.

8) The accessory according to any one of the preceding claims, wherein said suction device is set downstream of the second chute (38) of the pyramidal deviator (35).

9) The accessory according to any one of the preceding claims, wherein said suction device comprises means (42) for height adjustment with respect to the surface of feed of the sheet of paper.

10) The accessory according to any one of the preceding claims, wherein said suction means comprise an assembly (45) for collecting the residual particles sucked in provided with a manifold (43), which is in turn connected via pipes (44) to the suction device (47) and connected at outlet via a pipe (46) to the reservoir (33).

11) The accessory according to any one of the preceding claims, wherein said suction means comprise an air-outlet filter (48).

12) The accessory according to any one of the preceding claims, wherein said particles comprise glitter, microdrops, pigments or other materials of different colours and dimensions for creating a uniquely diversified mark.

13) The accessory according to any one of the preceding claims, wherein said particles comprise encapsulated microdrops and said stabilization means comprise a roll for squeezing the microcapsules on the portion (4) and a lamp for drying the squeezed microdrops.

14) The accessory according to any one of the preceding claims, wherein said particles comprise microdrops encapsulated in a water-soluble shell and said adhesive portion (4) of the sheet of paper comprises a layer of water-based paint.

15) The accessory according to any one of the preceding claims, wherein said means for sprinkling an adjustable amount of particles on an adhesive portion (4) of the sheet of paper comprise sprinkling cylinders (19), enveloping rings (6), and a suction plate (2), and said means for stabilizing said marking particles sprinkled on said adhesive portion (4) comprise squeezing rolls (11, 12), wherein said cylinders, enveloping rings, suction plate, and rolls have a diameter, length, and width that can vary according to the volumetric requirements of application, insertion, and adaptation to the type of each printing machine.

16) The accessory according to claim 15, characterized in that the sprinkling cylinders, the compressed-air suction plate, and the squeezing rolls can be assembled together in a single compact unit of appropriate dimensions according to the requirements of the machine on which it is to be applied.

17) The accessory according to any one of the preceding claims, characterized in that exit of the product and the pyramid with overflow groove that regulates dropping of the microdrops of colour on the square with paint can be computerized and synchronised automatically with the rate of feed of the paper via a motor and a photocell.

18) The accessory according to any one of the preceding claims, characterized in that the accessory as a whole can be inserted in the printing machine with a fixed or mobile structure according to the various requirements and types of machine or be applied off the printing line on other accessory machines or as stand-alone machine or inserted, during production, in new printing machines, or adapted via positioning rails also on ?planar printing machines.

19) The accessory according to any one of the preceding claims, characterized in that it can sprinkle plastic products, metal products, or products of any other type, with dimensions that vary according to the graphic needs and the size of the unique mark.

20) A printing apparatus for creating a unique pattern on a sheet by sprinkling marking particles, comprising at least one accessory according to any one of the preceding claims, applied to a printing line provided with a surface (31) for feeding a sheet of paper (32).

21) A method to be implemented by means of any printing line provided with a surface (31) for feeding a sheet of paper (32) for creating a unique pattern on said sheet by sprinkling marking particles, comprising in combination the following steps:
feeding a sheet of paper (31) provided with an adhesive portion (4);
sprinkling an adjustable amount of marking particles on said adhesive portion;
sucking in from said sheet a residual amount of particles not withheld by the adhesive portion; and
stabilizing the marking particles withheld by the adhesive portion.

22) The method according to claim 21, wherein said adhesive portion is obtained by applying a layer of transparent paint on said portion.

23) The method according to claim 22, wherein said marking particles comprise microgranules of coloured pigments encapsulated in a brittle water-soluble shell, and said paint is a water-based paint.

24) The method according to any one of claims 21-23, wherein a step of recirculation of the residual particles not withheld by the adhesive portion is envisaged.

25) The method according to any one of claims 21-24, wherein said stabilization step is obtained by squeezing the microdrops withheld on the adhesive portion (4) and subsequent drying thereof.

26) The method according to any one of claims 21-25, for creating a uniquely differentiated pattern via graphic printing with transparent paint and microgranules of water-soluble pigments of various colours, characterized in that it comprises various steps of sprinkling of microgranules of coloured pigments or, microdrops of colour, suction of the microgranules of pigments or microdrops, and drying of the paint with heat lamps or UV lamps, said sprinkling, suction, and drying being implementable with a single accessory that combines all three functions and is applied directly on the Printing line of the graphic printing machine or inserted therein in the production stage.

27) The method for creating a uniquely differentiated pattern via graphic printing with transparent paint and microgranules of water-soluble pigments or microdrops of colour of various colours according to any one of claims 21-26, characterized in that the pigments may be organic or inorganic, natural or artificial, such as carminic acids, antocyanins, luteins, etc. and selected according to the covering power, brightness, refractive index, stability to light and humidity, and drying rate.

28) The method for creating a uniquely differentiated pattern via graphic printing with transparent paint and microgranules of water-soluble pigments or microdrops of colour of various colours according to any one of claims 21-27, characterized in that the coloured pigments may be microgranulated with drying oils, essential or volatile oils, wax media, animal or vegetable glues, or synthetic binders, such as acrylic emulsions, synthetic resins, such as copolymers having a base of ethyl or methyl methacrylate, ketonic resins, alkyl and epoxy resins, etc.

29) The method for creating a uniquely differentiated pattern via graphic printing with transparent paint and microgranules of water-soluble pigments or microdrops of colour of various colours according to any one of claims 21-28, characterized in that the transparent paint can be dosed and formulated according to the requirements of anchorage, drying, and adhesiveness on the substrate on which it is printed (paper, plastic, cardboard, etc.).
